(19) United States
(12) Patent Application Publication
(10) Pub. No.: US 2002/0186458 A1
(43) Pub. Date: Dec. 12, 2002

(54) DYNAMICALLY CONTROLLED OPTICAL AMPLIFIER MODULE

(75) Inventors: Renyuan Gao, Strafford, PA (US); Renfeng Gao, Phoenixville, PA (US)

Correspondence Address: JOSEPH E. MAENNER, MONTE & MCGRAW, P.C., P.O. BOX 650, 4007 SKIPPACK PIKE, SKIPPACK, PA, 19474, US

(73) Assignee: Photon-X, Inc., Malvern, PA

(21) Appl. No.: 09/877,760

(22) Filed: Jun. 8, 2001

(51) Int. Cl. H01S 3/00

(52) U.S. Cl. 359/341.4

(57) ABSTRACT

A controllable optical amplifier module is disclosed. The controllable optical amplifier module includes a signal line. The signal line includes an input for receiving an input signal, an output for discharging an amplified signal such that the output is optically connected to the input, a gain medium optically disposed between the input and the output, and a first tap for generating a first tapped signal such that the first tap is optically disposed between the input and the output. The controllable optical amplifier module also includes at least one pump laser having a laser output optically connected to the gain medium and an ability to adjustably alter the intensity of the amplified signal. A method of adjustably amplifying an optical signal is also disclosed.

### FIELD OF THE INVENTION

The present invention relates to optical amplifiers that dynamically control amplification of optical signals.

### BACKGROUND OF THE INVENTION

Rare earth doped optical fiber amplifiers are emerging as the predominant optical signal amplification device for every aspect of optical communication networks spanning from repeaters, pre-amplifiers, and power boosters to wavelength division multiplexed (WDM) systems. An optical amplifier amplifies an optical signal directly in the optical domain without converting the optical signal into an electrical signal prior to amplification.

These amplifiers are suitable for long-haul, submarine, metro, community antenna television (CATV), and local area networks. As modern telecommunication networks increasingly require robustness, flexibility, re-configurability, and reliability, an ever growing demand exists for compact, low cost, and automatically controlled optical fiber amplification devices. In re-configurable dense wavelength division multiplexed (DWDM) systems with optical add-drop multiplexing (OADM), the input signal power undergoes variations as the channel configurations or the operating conditions change.

Gain controlled optical amplification has been implemented with various feedback mechanisms, including opto-electronic or all optical feedback loops. In the prior art, a known optical amplifier is controlled with an opto-electronic feedback circuit that stabilizes the optical signal gain to a certain pre-fixed level. The optical amplifier can be placed in an optical feedback loop such as a laser cavity to clamp the gain of the optical amplifier. However, the signal gain level and the optical amplifier operating conditions are pre-fixed, and can not be controlled dynamically from a remote central system.

It would be beneficial to have a stabilized optical amplifier device that automatically adjusts its signal gain or its signal output power. Furthermore, it would be beneficial to have an optical amplifier which can be dynamically controlled and adjusted by a central system via a communication port, such as a General purpose Interface Board (GPIB) or an RS-232 port.

### BRIEF SUMMARY OF THE INVENTION

Briefly, the present invention provides a controllable optical amplifier module. The controllable optical amplifier module comprises a signal line. The signal line includes an input for receiving an input signal, an output for discharging an amplified signal such that the output is optically connected to the input, a gain medium optically disposed between the input and the output, and a first tap for generating a first tapped signal, such that the first tap is optically disposed between the input and the output. The controllable optical amplifier module also comprises at least one pump laser having a laser output optically connected to the gain medium and means for adjustably altering the intensity of the amplified signal operatively connected to the signal line.

The present invention also provides a controllable optical amplifier module. The controllable optical amplifier module comprises a signal line. The signal line includes an input, an output optically connected to the input, a gain medium optically disposed between the input and the output, and a first tap for generating a first tapped signal and a second tap for generating a second tapped signal such that the first and second taps are optically disposed between the input and the output. The controllable optical amplifier module also comprises at least one pump laser having a laser output optically connected to the gain medium and a microprocessor opto-electronically connected to the first tap and the second tap, and electronically connected to the at least one pump laser. The microprocessor adjustably alters the output of the at least one pump laser to the gain medium based on a comparison of the first tapped signal and the second tapped signal.

Further, the present invention provides a controllable optical amplifier module. The controllable optical amplifier module comprises a signal line. The signal line includes an input, an output optically connected to the input, a gain medium optically disposed between the input and the output, a first tap for generating a first tapped signal, and a variable attenuator. The first tap and the variable attenuator are optically disposed between the gain medium and the output. The controllable optical amplifier module also comprises at least one pump laser having a laser output optically connected to the gain medium and a microprocessor opto-electronically connected to the first tap and electronically connected to the variable attenuator. The microprocessor adjustably alters the attenuation of the variable attenuator based on a value of the first tapped signal.

Also, the present invention comprises a method of controllably amplifying an optical signal in an optical gain medium. The method comprises providing an input optical signal; transmitting the input optical signal to the gain medium; transmitting a pump signal to the gain medium; amplifying the input optical signal in the gain medium, generating an amplified signal; transmitting the amplified signal to an output; tapping at least one of the input optical signal and the amplified signal, generating at least one tapped signal; transmitting the at least one tapped signal to a processor; processing the at least one tapped signal to generate a control signal; and adjustably altering the amplified signal based on the value of the control signal.

Additionally, the present invention comprises a method of controllably amplifying an optical signal in an optical gain medium. The method comprises providing an input optical signal; transmitting the input optical signal to the gain medium; transmitting a pump signal to the gain medium, the pump signal amplifying the input optical signal in the gain medium, generating an amplified signal; transmitting the amplified signal to an output; tapping each of the input optical signal and the amplified signal, generating first and second tapped signals; transmitting the first and second tapped signals to a processor; processing the first and second tapped signals to generate a control signal; and adjustably altering the strength of the pump signal based on the value of the control signal.

Also, the present invention provides a method of controllably amplifying an optical signal in an optical gain medium. The method comprises providing an input optical signal; transmitting the input optical signal to the gain medium; transmitting a pump signal to the gain medium, the pump signal amplifying the input optical signal in the gain medium, generating an amplified signal; transmitting the amplified signal to an output; tapping into the amplified signal to provide a first tapped signal; transmitting the first tapped electronic signal to a processor; generating a control signal in the processor based on the first tapped signal; transmitting the control signal to a variable attenuator optically disposed upstream of the first tapped signal; and adjustably altering the attenuation of the variable attenuator to regulate the intensity of the amplified signal.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic drawing of a first embodiment of the present invention.

FIG. 2 is an exploded perspective view of an amplifier module according to the present invention.

FIG. 3 is a perspective view of an amplifier module according to the present invention.

FIG. 4 is a schematic drawing of a second embodiment of the present invention.

### DETAILED DESCRIPTION OF THE INVENTION

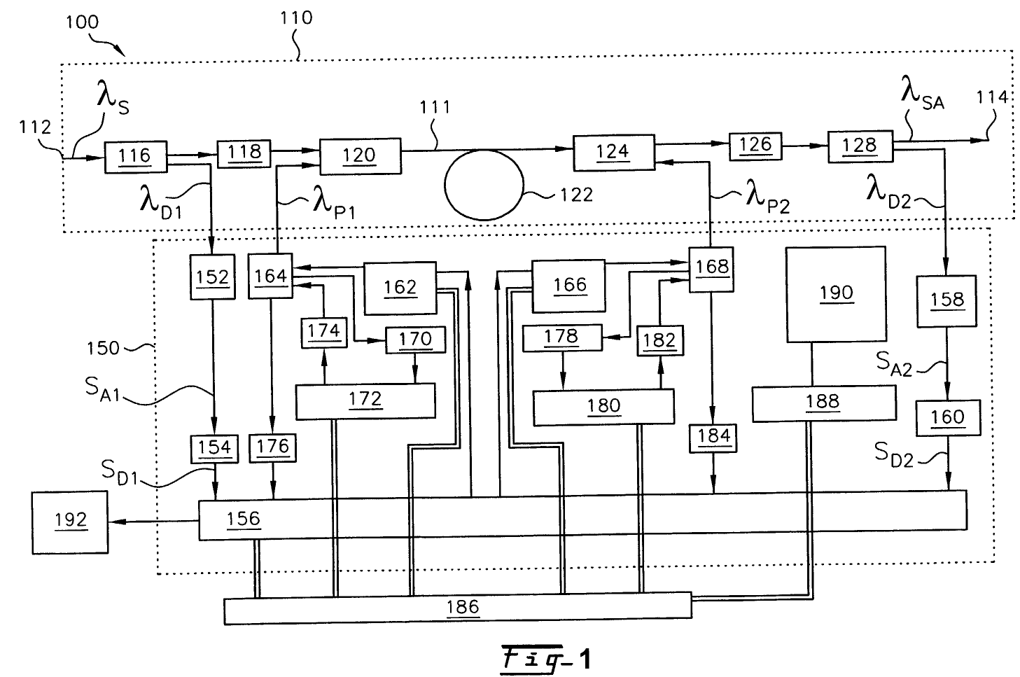

In the drawings, like numerals indicate like elements throughout. A schematic drawing of a first preferred embodiment of the present invention is shown in FIG. 1. An amplifier module 100 is used to amplify optical signals transmitted along a fiber optic system. As is well known in the art, the intensity of an optical signal degrades over distance due to a variety of factors, including impurities in the fiber and losses at connections, as well as other factors. In a fiber optic system which may extend several hundreds of kilometers, a plurality of amplifier modules 100 can be strategically located in the system to amplify the optical signals along the length of the system.

The amplifier module 100 is comprised of a photonics layer 110 and an electronics layer 150. An electronics layer 150 which can be used is disclosed in U.S. patent application Ser. No. 09/______ (PHX-0013), filed on even date, which is owned by the assignee of the present invention, and is incorporated by reference herein in its entirety. Although the electronics layer 150 as described above is preferred, those skilled in the art will recognize that electronics layers with other features can be used as well.

The photonics layer 110 includes an input 112 and an output 114. Optically disposed between the input 112 and the output 114, from left to right, as shown in FIG. 1, are a first tap 116; a gain equalization filter 118; a first wavelength division multiplexor (WVDM)/isolator assembly 120; a gain medium, such as an erbium doped fiber (EDF) 122; a second WDM/isolator assembly 124; an amplified spontaneous emission (ASE) filter 126; and a second tap 128. Each of the input 112, the output 114, the first tap 116; the gain equalization filter 118; the first wavelength division multiplexor (WDM)/isolator assembly 120; the gain medium, such as an erbium doped fiber (EDF) 122; the second WDM/isolator assembly 124; the amplified spontaneous emission (ASE) filter 126; and the second tap 128 are preferably optically connected to adjacent components by a light transferring medium, such as an optical fiber or a waveguide, although those skilled in the art will recognize that the afore-mentioned components can be connected by free space, as well. As used herein, when components are said to be “optically connected”, light signals can be transmitted between the components. Additionally, when other components are said to be “optically disposed” between first and second components, light signals can be transmitted between the first and second components serially through the other components.

Further, although the gain medium 122 is preferably an erbium doped fiber, fibers doped with other rare earth elements, or combinations of other rare earth elements or other metal elements, as disclosed in U.S. patent application Ser. No. 09/507,582, filed Feb. 18, 2000, Ser. No. 09/722,821, filed Nov. 28, 2000, and Ser. No. 09/722,822, filed Nov. 28, 2000, which are owned by the assignee of the present application, and which are incorporated herein in their entirety, can be used. Although the gain medium 122 is preferably a fiber, those skilled in the art will recognize that the gain medium 122 can also be a waveguide or other doped photon transmitting device. The devices in the photonics layer 110 comprise a signal line 111 in a first direction from the input 112 to the output 114, along which an input signal λ_{S} is transmitted.

In addition to being optically disposed between the input 112 and the gain equalization filter 118, the first tap 116 is optically connected to a first photodetector 152 in the electronics layer 150. The first photodetector 152 is electronically connected to a first analog to digital (A/D) converter 154 and the first A/D converter 154 is electronically connected to a microprocessor 156. The first tap 116 is therefore opto-electronically connected to the microprocessor 156. Two components are “electronically connected” to each other when an electronic signal can be transmitted between the two components. Two components are “opto-electronically connected” when an optical signal is transmitted from one component and converted into an electronic signal, which is transmitted to the second component.

In addition to being optically disposed between the ASE filter 128 and the output 114, the second tap 128 is optically connected to a second photodetector 158 in the electronics layer 150. The second photodetector 158 is electronically connected to a second A/D converter 160 and the second A/D converter 160 is electronically connected to the microprocessor 156. Similar to the first tap 116, the second tap 128 is opto-electronically connected to the microprocessor 156.

The microprocessor 156 is electronically connected to a first current source 162. The first current source 162 controls a first pump laser 164. Output from the first pump laser 164 is optically connected to the signal line 111 between the gain equalization filter 118 and the first WDM/isolator assembly 120 such that a pump signal λ_{P1} enters the signal line 111 and is transmitted in the first direction toward the output 114 with the input signal λ_{S}.

The microprocessor 156 also is electronically connected to a second current source 166. The second current source 166 controls a second pump laser 168. Output from the second pump laser 168 is optically connected to the signal line 111 between the second WDM/isolator assembly 124 and the ASE filter 126 such that a pump signal λ_{P2} enters the signal line 111 and is transmitted in a second direction, toward the input 112, and opposite the direction of the input signal λₛ.

The amplifier module 100 according to the present invention uses a feedback loop in which the input signal λ_{S} and an amplified signal λ_{SA} are constantly compared to each other to determine the amount of amplification required to amplify the input signal λₛ to a desired amplified signal λ_{SA}. The amplifier module 100 dynamically and continuously varies the amplification intensity of the input signal λ_{S} through operation of the pump lasers 164, 168 to obtain the desired intensity of the amplified signal λ_{SA}.

Preferably, the first and second pump lasers 164, 168 are 980 nanometer lasers, having an output power of between approximately 20 mW and 300 mW, although those skilled in the art will recognize that other types of pump lasers having different wavelengths and different output power ranges can be used.

The first pump laser 164 includes a first thermistor 170, which senses the temperature of the first pump laser 164. Output from the first thermistor 170 is electrically connected to a first thermoelectric cooler (TEC) controller 172, which controls a first TEC 174. The first pump laser 164 is also connected to a first laser A/D converter 176, which converts an analog signal from the first pump laser 164 to a digital signal for transmission to the microprocessor 156. Similarly, the second pump laser 168 includes a second thermistor 178, which senses the temperature of the second pump laser 168. Output from the second thermistor 178 is electrically connected to a second TEC controller 180, which controls a second TEC 182. The second pump laser 168 is also connected to a first laser AID converter 184, which converts an analog signal from the second pump laser 168 to a digital signal for transmission to the microprocessor 156. The microprocessor 156 uses the digital signals from the first and second laser A/D converters 176, 184 to determine the amount of current which must be supplied to the pump lasers 164, 168 from the respective current sources 162, 166 in order to achieve the desired amplified signal λ_{SA}. Those skilled in the art will recognize the use of a TEC with a laser is well known and further description of the relation of the first and second TECs 174, 182 with their respective pump lasers 164, 168 will not be necessary.

Although first and second pump lasers 164, 168 are preferred, those skilled in the art will recognize that only one pump laser, or more than two pump lasers, can be used.

The microprocessor 156, the first and second current sources 162, 166, and the first and second TEC controllers 172, 180 are all electrically connected to a power source 186, which provides electrical power to the aforementioned components. Additionally, a system TEC controller 188, which controls a system TEC 190, is also powered by the power source 186. Those skilled in the art will recognize that the system TEC 190 is optional and can be omitted from the module 100.

The amplifier module 100 is controlled by a computer or controller 192, which is electronically connected to the microprocessor 156 via a GPIB or an RS-232 port. The controller 192 controls the microprocessor 156 to dynamically change the maximum gain desired in the amplifier module 100. Those skilled in the art will recognize that, for a fiber optic system with a plurality of amplifier modules 100, each amplifier module 100 can have its own controller 192, or several or all of the amplifier modules 100 in the system can be connected to a single controller 192.

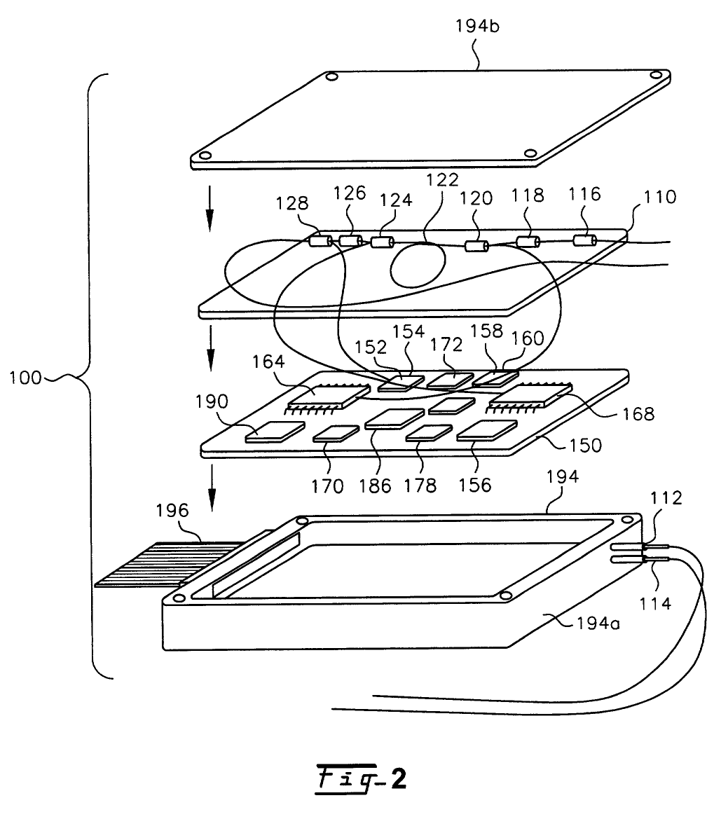

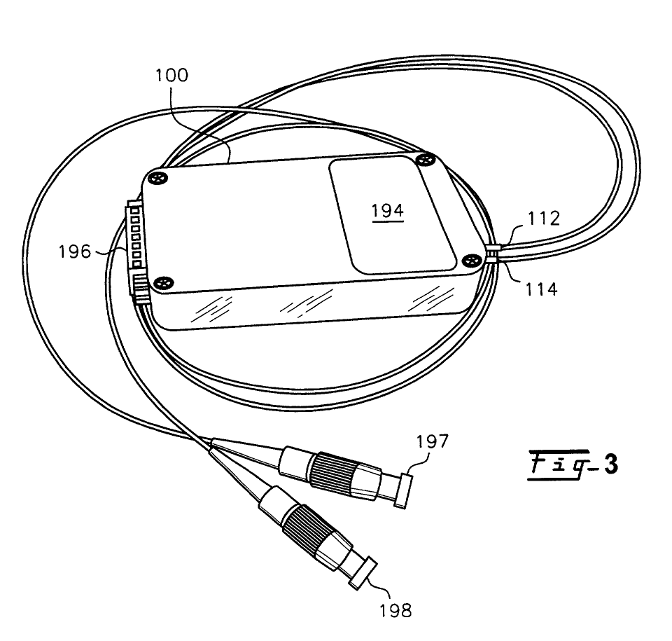

Preferably, the photonics layer 110 is disposed in a separate layer from the electronics layer 150, so that the two layers 110, 150 can be stacked, one on top of the other, in a housing 194, as shown in the exploded view of the amplifier module 100 shown in FIG. 2. The housing 194 comprises a lower portion 194a and an upper portion 194b, which can be separated to accommodate installation of the photonics layer 110 and the electronics layer 150. The input 112 and the output 114 extend from a side wall of the lower portion 194a. A controller port 196, such as for a GPIB or an RS-232 connection, also extends from a side wall of the lower portion 194a. A fully assembled amplifier module 100 is shown in FIG. 3, with optical connectors 197, 198 optically connected to the input 112 and output 114, respectively.

Preferably, the housing 194 is a constructed from a thermally conductive composite material to enhance thermal dissipation. Alternatively, the housing 194 can be constructed from a metal, such as aluminum or other suitable metal. Preferably, the housing 194 has orthogonal dimensions of approximately 11.5 centimeters long ×7.6 centimeters wide ×1.9 centimeters high, for a total volume of approximately 166 cubic centimeters.

In operation, the input signal λₛ is provided at the input 112 to the amplifier module 100. The input signal λₛ is transmitted in the first direction from the input 112 toward the output 114. Preferably, the input signal λₛ has a wavelength of between approximately 1260 nanometers and 1610 nanometers. The input signal λ_{S} is transmitted along the signal line 111 to the first tap 116. A portion of the input signal λ_{S} is diverted by the first tap 116 and becomes the first diverted signal λ_{D1} The portion of the input signal λ_{S} which is not diverted is further transmitted along the signal line 111 to the gain equalization filter 118, which attenuates the different wavelengths of the input signal λ_{S} to provide equalized gain throughout the wavelengths of the input signal λ_{S}. The input signal λ_{S} is further transmitted toward the first WDM/isolator assembly 120, where the first pump signal λ_{P1} is combined with the signal line 111. Generation of the first pump signal λ_{P1} will be described later herein. The WDM portion of the first WDM/isolator assembly 120 couples the input signal λ_{S} and the first pump signal λ_{P1}. The isolator portion of the first WDM/isolator assembly 120 eliminates light between the WDM/isolator assembly 120 and the output 114 which may be reflected backward toward the input 112. The combined input signal λ_{S} and first pump signal λ_{P1} are then transmitted to the gain medium 122. The first pump signal λ_{P1} stimulates the rare earth ions in the gain medium 122, which in turn, amplify the input signal λ_{S} to generate the amplified signal λ_{SA} as is well known by those skilled in the art. As the first pump signal λ_{P1} is transmitted along the gain medium 122, the first pump signal λ_{P1} decays, decreasing the ability of the first pump signal λ_{P1} to excite the rare earth ions in the gain medium 122, which in turn decreases the amplification of the input signal λ_{S}.

The amplified signal λ_{SA} is then transmitted to the second WDM/isolator assembly 124. The second pump signal λ_{P2} is transmitted through the WDM/isolator assembly 124, which combines the second pump signal λ_{P2} and the signal line 111. The WDM portion of the second WDM/isolator assembly 124 couples the amplified signal λ_{SA} and the second pump signal λ_{P2}. The isolator portion of the second WDM/isolator assembly 124 eliminates light between the WDM/isolator assembly 124 and the output 114 which may be reflected backward toward the input 112. The second pump signal λ_{P2} is transmitted along the signal line 111 toward the input 112 and to the gain medium 122, where the second pump signal λ_{P2} stimulates the rare earth ions in the gain medium 122. The stimulated rare earth ions amplify the input signal λ_{S} to assist the first pump signal λ_{P1} generate the amplified signal λ_{SA}. As the second pump signal λ_{P2} is transmitted along the gain medium 122 toward the input 112, the second pump signal λ_{P2} decays, decreasing the ability of the second pump signal λ_{P2} to excite the rare earth ions in the gain medium 122, which in turn decreases the amplification of the input signal λ_{S}.

The amplified signal λ_{SA} is transmitted to the ASE filter 126 which blocks amplified spontaneous emission noise. The amplified signal λ_{SA} is then transmitted to the second tap 128. A portion of the amplified signal λ_{SA} is diverted by the second tap 128 and becomes the second diverted signal λ_{D2}. The remainder of the amplified signal λ_{SA} is discharged from the amplifier module 100 through the output 114.

The first diverted signal λ_{D1} is transmitted to the first photodetector 152, which converts the first diverted signal λ_{D1} to a first analog signal λ_{A1}. The first analog signal λ_{A1} is then transmitted to the first analog to digital (A/D) converter 154, which converts the first analog signal λ_{A1} to a first digital signal λ_{D1}. The first digital signal λ_{D1} is then transmitted to the microprocessor 156.

Similarly, the second diverted signal λ_{D2} is transmitted to the second photodetector 158, which converts the second diverted signal λ_{D2} to a second analog signal λ_{A2}. The second analog signal λ_{A2} is then transmitted to the second A/D converter 160, which converts the second analog signal λ_{A2} to a second digital signal λ_{D2}. The second digital signal SD₂ is then transmitted to the microprocessor 156.

The microprocessor 156 compares the first digital signal λ_{D1} to the second digital signal λ_{D2} and calculates the signal gain level between the input signal λ_{S} and the amplified signal λ_{SA}. As a result of the calculation, the microprocessor 156 determines whether the first and second pump signals λ_{P1}, λ_{P2} are insufficient or too strong to generate the amplified signal λ_{SA} at a predetermined desired power. The microprocessor 156 then sends a signal to each of the first and second current sources 162, 166, respectively, to adjust the output power of each of the first and second pump lasers 164, 168, respectively. Increasing the output power of the first and second pump lasers 164, 168 increases the strength of the first and second pump signals λ_{P1}, λ_{P2}, thus increasing the amplification of the input signal λ_{S} to the desired amplified signal λ_{SA}. Similarly, decreasing the output power of the first and second pump lasers 164, 168 decreases the strength of the first and second pump signals λ_{P1}, Xp₂, thus decreasing the amplification of the input signal λ_{S} to the desired amplified signal λ_{SA}.

Preferably, a desired gain of the amplified signal λ_{SA} over the input signal λ_{S} is approximately 30 dB, although those skilled in the art will recognize that other gain values can be achieved in the manner described above. The controller 192 can transmit a signal to the microprocessor 186 to adjustably alter the desired signal gain level between the input signal λ_{S} and the amplified signal λ_{SA}. As a result, the value of the control signal as well as the gain level of the amplifier module 100 are continuously and dynamically adjustable.

Alternatively, instead of using the amplifier module 100 to adjustably alter the signal gain level, the microprocessor 156 can be programmed to limit the maximum intensity of the amplified signal λ_{SA}. In such a configuration, the microprocessor 156 is programmed to process only the second tapped signal λ_{D2} from the second tap 128. If the microprocessor 156 determines that the intensity of the amplified signal λ_{SA} is too great, the microprocessor 156 sends a signal to each of the first and second current sources 162, 166 to decrease the amount of current being sent to each of the first and second lasers 164, 168, respectively, which in turn decreases the strength of the first and second pump signals λ_{P1}, λ_{P2}, thus decreasing the amplification of the input signal λ_{S} to the desired maximum intensity for the amplified signal λ_{SA}.

Preferably, a maximum amplified signal λ_{SA} is approximately 25 dBm, or approximately 317 mW, although those skilled in the art will recognize that other values can be achieved as well. The controller 192 can transmit a signal to the microprocessor 186 to adjustably alter the desired intensity of the amplified signal λ_{SA}. As a result, the value of the control signal as well as the output level of the amplifier module 100 are continuously and dynamically adjustable.

Similarly, if the microprocessor 156 determines that the intensity of the amplified signal λ_{SA} is too low, the microprocessor 156 sends a signal to each of the first and second current sources 162, 166 to increase the amount of current being sent to each of the first and second lasers 164, 168, respectively, which in turn increases the strength of the first and second pump signals λ_{P1}, λ_{P2}, thus increasing the amplification of the input signal λ_{S} to the desired maximum intensity for the amplified signal λ_{SA}.

Although it is preferred either to limit a maximum desired amount of gain or to limit a maximum desired intensity of the amplified signal λ_{SA}, those skilled in the art will recognize that the amplifier module 100 can be used to limit a maximum desired intensity of the amplified signal λ_{SA}, with the gain not to exceed a predetermined value.

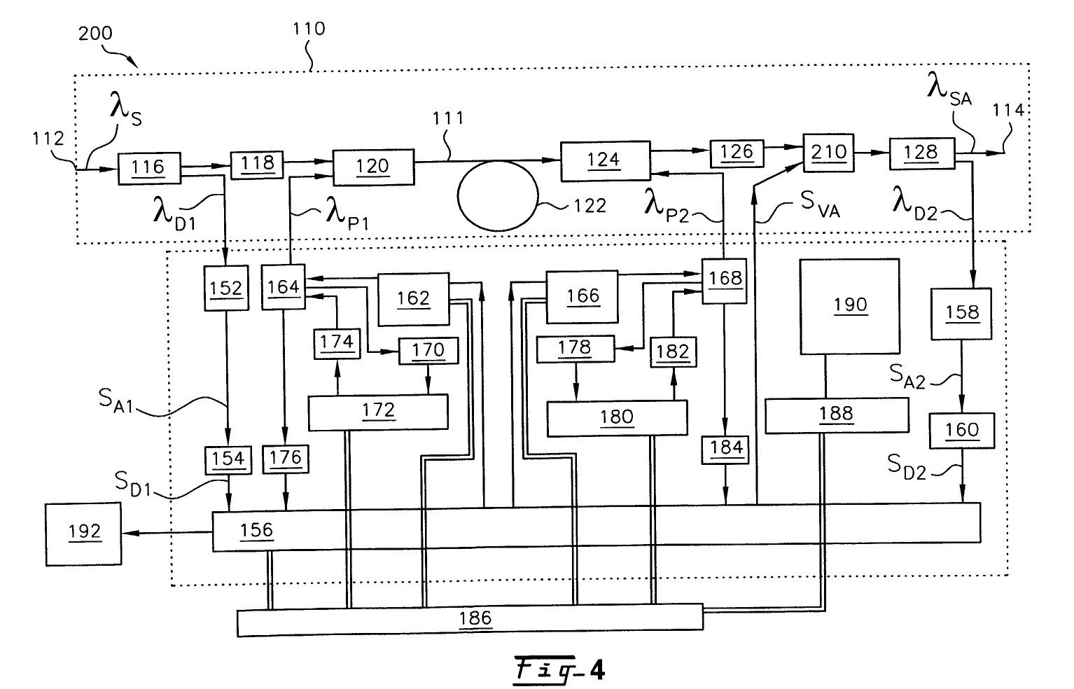

A second embodiment of the present invention is shown schematically in FIG. 4. A dynamic amplifier module 200 is similar to the amplifier module 100 as described above, with the exception of an added variable attenuator 210, which is optically disposed in the signal line 111 between the ASE filter 126 and the second tap 128. The variable attenuator 210 is electronically connected to the microprocessor 156 to receive signals S_{VA} from the microprocessor 156 to attenuate the amplified signal λ_{SA} based on feedback from the second tap 128, which provides information about the intensity of the amplified signal λ_{SA} to the microprocessor 156.

Operation of the amplifier module 200 is similar to the operation of the amplifier module 100 except that, while the amplifier module 100 adjusts the intensity of the pump signals λ_{P1}, λ_{P2} to limit the maximum gain of the amplifier module 100, the amplifier module 200 uses the variable attenuator to limit the maximum gain of the amplifier module. Preferably, a desired gain of the amplified signal λ_{SA} over the input signal λ_{S} is approximately 10 to 25 dB, although those skilled in the art will recognize that other gain values can be achieved in the manner described above. The controller 192 can transmit a signal to the microprocessor 186 to adjustably alter the desired signal gain level between the input signal λ_{S} and the amplified signal λ_{SA}. As a result, the value of the control signal as well as the gain level of the amplifier module 100 are continuously and dynamically adjustable.

In operation, the input signal λ_{S} is transmitted along the signal line 111, where the input signal λ_{S} is amplified to the amplified signal λ_{SA} by laser signals generated by the pump lasers 164, 168, respectively. The second tap 128 diverts a small percentage of the amplified signal λ_{SA}, the second tapped signal λ_{D2}, to the microprocessor 156 through the second photodetector 158 and the second A/D converter 160, as described above. The microprocessor 156 determines the intensity of the amplified signal λ_{SA} based on the value of the signal received from the A/D converter 160. The microprocessor 156 then compares the intensity of the amplified signal λ_{SA} to a predetermined desired amplified signal λ_{SA} and, if the intensity of the amplified signal λ_{SA} is higher than the predetermined desired amplified signal λ_{SA}, the microprocessor 156 sends a signal to the variable attenuator 210 to attenuate the amplified signal λ_{SA} to provide a predetermined desired maximum gain level. If the gain level is less than the predetermined desired gain level, the microprocessor 156 sends a signal to the variable attenuator 210 to decrease attenuation of the amplified signal λ_{SA} to an gain level equal to the intensity of the predetermined desired gain level.

Alternatively, instead of using the amplifier module 200 to adjustably alter the signal gain level, the microprocessor 156 can be programmed to limit the maximum intensity of the amplified signal λ_{SA}. In such a configuration, the microprocessor 156 is programmed to process only the second tapped signal λ_{D2} from the second tap 128. If the microprocessor 156 determines that the intensity of the amplified signal λ_{SA} is greater than the predetermined desired output signal, the microprocessor 156 sends a signal to the variable attenuator 210 to increase the attenuation of the amplified signal λ_{SA}, thus reducing the intensity of the amplified signal λ_{SA} prior to the amplified signal λ_{SA} reaching the output 114 of the amplifier module 200.

Similarly, if the intensity of the amplified signal λ_{SA} is less than the predetermined desired output signal, the microprocessor 156 sends a signal to the variable attenuator 210 to decrease attenuation of the amplified signal λ_{SA} to provide an intensity equal to the intensity of the predetermined desired amplified signal λ_{SA}.

Preferably, a maximum amplified signal λ_{SA} is approximately 25 dBm, or approximately 317 mW, although those skilled in the art will recognize that other values can be achieved as well. The controller 192 can transmit a signal to the microprocessor 186 to adjustably alter the desired intensity of the amplified signal λ_{SA}. As a result, the value of the control signal as well as the output level of the amplifier module 200 are continuously and dynamically adjustable.

Although it is preferred either to limit a maximum desired amount of gain or to limit a maximum desired intensity of the amplified signal λ_{SA}, those skilled in the art will recognize that the amplifier module 200 can also be used to limit a maximum desired amount of gain, with the amplified signal λ_{SA} not to exceed a predetermined intensity.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A controllable optical amplifier module comprising:
a signal line including:
an input for receiving an input signal;
an output for discharging an amplified signal, the output being optically connected to the input;
a gain medium optically disposed between the input and the output; and
a first tap for generating a first tapped signal, the first tap being optically disposed between the input and the output;
at least one pump laser having a laser output optically connected to the gain medium; and
means for adjustably altering the intensity of the amplified signal operatively connected to the signal line.

2. The controllable optical amplifier module according to claim 1, wherein the means for adjustably altering the intensity of the amplified signal increases the intensity of the input signal to a maximum predetermined value.

3. The controllable optical amplifier module according to claim 2, wherein the means for adjustably altering the intensity of the amplified signal comprises:
a variable attenuator optically disposed between the input and the first tap; and
a microprocessor operatively connected to the first tap and the variable attenuator, wherein the microprocessor adjustably alters the attenuation of the variable attenuator based on the intensity of the first tapped signal.

4. The controllable optical amplifier module according to claim 2, wherein the first tap taps the amplified signal and the means for adjusting intensity of the amplified signal comprises a second tap and a microprocessor, wherein the second tap taps the input signal and the microprocessor compares the intensity of the tapped input signal to the tapped amplified signal and sends a control signal to the at least one pump laser, the control signal controlling the intensity of the at least one pump laser.

5. The controllable optical amplifier module according to claim 1, wherein the means for adjustably altering the intensity of the amplified signal increases the gain of the input signal to a maximum predetermined value.

6. The controllable optical amplifier module according to claim 5, wherein the first tap taps the amplified signal and the means for adjusting intensity of the amplified signal comprises a second tap and a microprocessor, wherein the second tap taps the input signal and the microprocessor compares the intensity of the tapped input signal to the tapped amplified signal and sends a control signal to the at least one pump laser, the control signal controlling the intensity of the at least one pump laser.

7. The controllable optical amplifier module according to claim 5, wherein the means for adjustably altering the intensity of the amplified signal comprises a variable attenuator optically disposed between the input and the first tap, and a microprocessor operatively connected to the first tap and the variable attenuator, wherein the microprocessor adjustably alters the attenuation of the variable attenuator based on the intensity of the first tapped signal.

8. The controllable optical amplifier module according to claim 1, wherein the microprocessor is electronically connected to a remote device.

9. The controllable optical amplifier module according to claim 1, wherein the controllable optical amplifier module is approximately 166 cubic centimeters in size.

10. The controllable optical amplifier module according to claim 1, wherein a maximum orthogonal length of the optical amplifier module is less than 11.5 centimeters.

11. The controllable optical amplifier module according to claim 1, wherein the signal line is disposed on a first layer and the microprocessor is disposed on a second layer within the controllable optical amplifier module.

12. The controllable optical amplifier module according to claim 1, wherein the signal line further comprises at least one optical isolator and wavelength division multiplexor coupler assembly optically disposed between the input and the output.

13. A controllable optical amplifier module comprising:
a signal line including:
an input;
an output optically connected to the input;
a gain medium optically disposed between the input and the output; and
a first tap for generating a first tapped signal and a second tap for generating a second tapped signal, the first and second taps being optically disposed between the input and the output;
at least one pump laser having a laser output optically connected to the gain medium; and
a microprocessor opto-electronically connected to the first tap and the second tap, and electronically connected to the at least one pump laser, the microprocessor adjustably altering the output of the at least one pump laser to the gain medium based on a comparison of the first tapped signal and the second tapped signal.

14. The controllable optical amplifier module according to claim 13, wherein the microprocessor is electronically connected to a remote device.

15. The controllable optical amplifier module according to claim 13, wherein the at least one pump laser comprises a first pump laser optically connected to the gain medium such to generate a first pump laser signal optically toward the output and a second pump laser optically connected to the gain medium such to generate a second pump laser signal optically toward the input.

16. A controllable optical amplifier module comprising:
a signal line including:
an input;
an output optically connected to the input;
a gain medium optically disposed between the input and the output;
a first tap for generating a first tapped signal; and
a variable attenuator, the first tap and the variable attenuator being optically disposed between the gain medium and the output;
at least one pump laser having a laser output optically connected to the gain medium; and
a microprocessor opto-electronically connected to the first tap and electronically connected to the variable attenuator, the microprocessor adjustably altering the attenuation of the variable attenuator based on a value of the first tapped signal.

17. The controllable optical amplifier module according to claim 16, wherein the microprocessor is electronically connected to a remote device.

18. The controllable optical amplifier module according to claim 16, wherein the at least one pump laser comprises a first pump laser optically connected to the gain medium such to generate a first pump laser signal optically toward the output and a second pump laser optically connected to the gain medium such to generate a second pump laser signal optically toward the input.

19. A method of controllably amplifying an optical signal in an optical gain medium, the method comprising:
providing an input optical signal;
transmitting the input optical signal to the gain medium;
transmitting a pump signal to the gain medium;
amplifying the input optical signal in the gain medium, generating an amplified signal;
transmitting the amplified signal to an output;
tapping at least one of the input optical signal and the amplified signal, generating at least one tapped signal;
transmitting the at least one tapped signal to a processor;
processing the at least one tapped signal to generate a control signal; and
adjustably altering the amplified signal based on the value of the control signal.

20. The method according to claim 19, wherein adjustably altering the amplified signal comprises adjustably altering the strength of the pump signal.

21. The method according to claim 19, wherein adjustably altering the amplified signal comprises adjustably attenuating the amplified signal prior to the output.

22. A method of controllably amplifying an optical signal in an optical gain medium, the method comprising:
providing an input optical signal;
transmitting the input optical signal to the gain medium;
transmitting a pump signal to the gain medium, the pump signal amplifying the input optical signal in the gain medium, generating an amplified signal;
transmitting the amplified signal to an output;
tapping each of the input optical signal and the amplified signal, generating first and second tapped signals;
transmitting the first and second tapped signals to a processor;
processing the first and second tapped signals to generate a control signal; and
adjustably altering the strength of the pump signal based on the value of the control signal.

23. The method according to claim 22, further comprising controlling the processor via a remote device.

24. A method of controllably amplifying an optical signal in an optical gain medium, the method comprising:
providing an input optical signal;
transmitting the input optical signal to the gain medium;
transmitting a pump signal to the gain medium, the pump signal amplifying the input optical signal in the gain medium, generating an amplified signal;
transmitting the amplified signal to an output; tapping into the amplified signal to provide a first tapped signal;
transmitting the first tapped electronic signal to a processor;
generating a control signal in the processor based on the first tapped signal;
transmitting the control signal to a variable attenuator optically disposed upstream of the first tapped signal; and
adjustably altering the attenuation of the variable attenuator to regulate the intensity of the amplified signal.

25. The method according to claim 24, further comprising controlling the processor via a remote device.
